(19) United States
(12) Patent Application Publication
(10) Pub. No.: US 2011/0032178 A1
(43) Pub. Date: Feb. 10, 2011

(54) Display Device

(75) Inventor: Chun-Hsien Lee, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/683,184

(22) Filed: Jan. 6, 2010

(30) Foreign Application Priority Data
Aug. 4, 2009 (TW) 98126176

(51) Int. Cl. G09G 3/36

(52) U.S. Cl. 345/87

(57) ABSTRACT

A display device comprising a panel, an optical guiding assembly and a tape assembly is provided. The tape assembly has a first adhesive and a second adhesive which is opposite the first adhesive. The tape assembly is able to be bent and adhered to the optical guiding assembly at the top and bottom peripheries thereof by the second adhesive. The panel is adhered to the first adhesive of the tape assembly and stacked onto the optical guiding assembly.

This application claims the benefit from the priority of Taiwan Patent Application No. 098126176 filed on Aug. 4, 2009, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention provides a display device with a continuous tape assembly.

2. Descriptions of the Related Art

With the development of image displaying technologies over recent years, liquid crystal displays (LCDs) are now lightweight, slim, power-saving and free of radiation. Due to these features, LCDs have gradually replaced conventional cathode ray tubes (CRTs) as mainstream products in the display market.

In addition to large-sized LCDs that are used as computer screens or large-scale display devices, small-sized LCDs are also widely used in various electronic products, e.g., mobile phones, cameras, personal digital assistants (PDAs) and the like. However, LCDs have a complex structure and require the use of a complex and precise manufacturing process, which is especially the case for small-sized LCDs. Accordingly, reducing production costs while still maintaining assembly quality have interested manufacturers.

An LCD mainly comprises a light source, a light guiding element, an optical film and a panel that are stacked on each other. Light projected by the light source passes through the light guiding element to form an area light source, and is then enhanced in brightness by the optical film before an image is finally displayed on the display panel. Locations of the stacked elements relative to each other are designed in advance and sequentially fixed during the assembly process. In the prior art, a frame structure is used to restrain the positions of the individual elements and adhesive tapes are used to adhere these elements together.

However, because conventional tapes are adhered to preset locations respectively during the assembly process, tapes of different shapes and length must be prepared for different portions. Conceivably, corresponding molds must be fabricated to produce such tapes of different sizes, and operations of adhering various tapes onto specific locations must be repeated during the assembly process of each LCD. Therefore, the conventional tapes require the use of costly molds and a rather complex manufacturing process, making it difficult to reduce the overall production cost of the LCDs.

In view of this, it is highly desirable in the art to provide a display device that adopts a new tape design to reduce the cost of the display devices.

### SUMMARY OF THE INVENTION

One objective of the present invention is to provide a display device which uses an integrally formed tape assembly as a medium to adhere individual elements of the display device together. For the production of the tape assembly, a single mold may be designed to reduce the production cost of the tape remarkably.

Another objective of the present invention is to provide a display device adopting a tape assembly of a continuous integral design. During the assembly process of the display device, the continuous design may reduce the number of times of aligning and adhering the tape and simplify the manufacturing process, thereby greatly increasing the assembly efficiency and reducing the overall production cost of the display device.

The present invention discloses a display device, comprising a panel, an optical guiding assembly and a tape assembly. The optical guiding assembly has a first periphery and a second periphery opposite the first periphery. The tape assembly has a first adhesive and a second adhesive opposite to the first adhesive. The tape assembly is bent and adhered to the optical guiding assembly at the first periphery and the second periphery thereof by the second adhesive in such a way that the first adhesive is exposed, and the panel is partially adhered to the first adhesive and stacked onto the first periphery of the optical guiding assembly.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a display device according to the present invention;

FIG. 2 is an exploded view of the display device according to the present invention;

FIG. 3A is a schematic view of a tape assembly according to a preferred embodiment of the present invention;

FIG. 3B is a schematic cross-sectional view of the tape assembly shown in FIG. 3A along a line 3B-3B′;

FIG. 4A is a top view of the display device according to the present invention;

FIG. 4B is a schematic cross-sectional view of the display device shown in FIG. 4A along a line 4B-4B′;

FIG. 4C is a schematic cross-sectional view of the display device shown in FIG. 4A along a line 4C-4C′;

FIG. 4D is a schematic view of the tape assembly when being adhered;

FIG. 5A is a top view of a display device according to another preferred embodiment of the present invention;

FIG. 5B is a schematic view of a tape assembly in the embodiment shown in FIG. 5A; and

FIG. 5C is a schematic partial cross-sectional view of the display device shown in FIG. 5A along a line 5C-5C′.

### DESCRIPTION OF THE PREFERRED EMBODIMENT

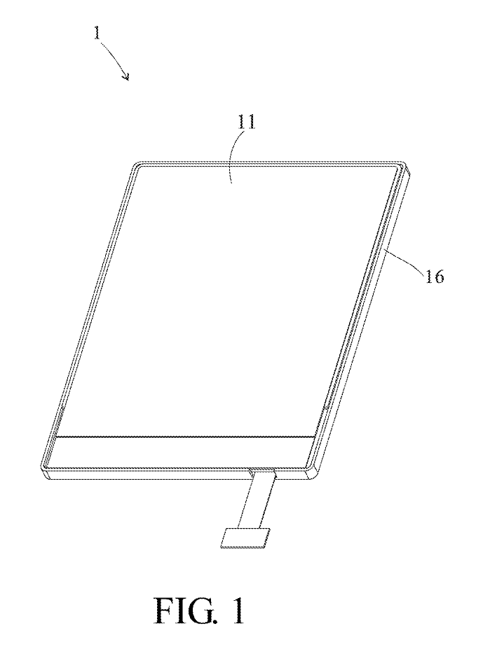

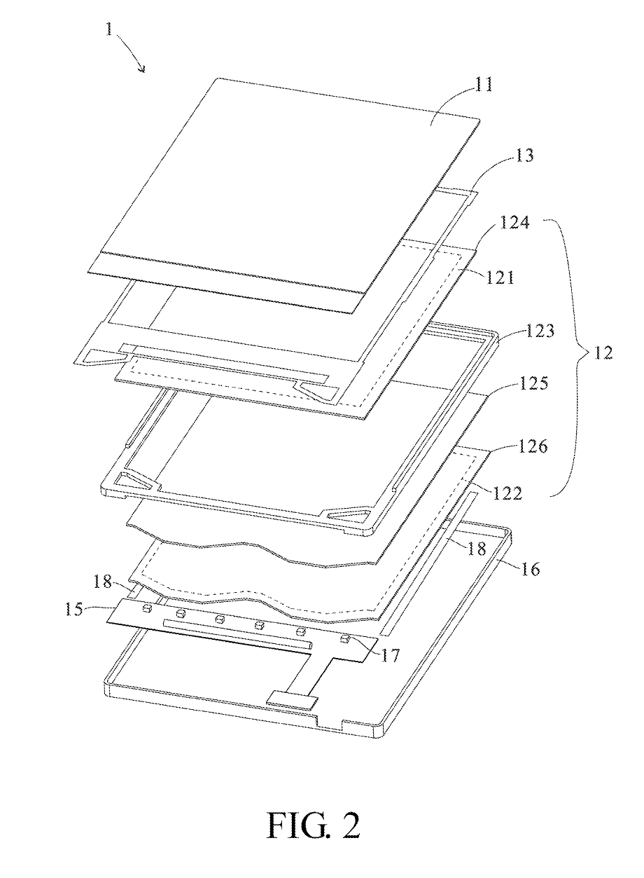

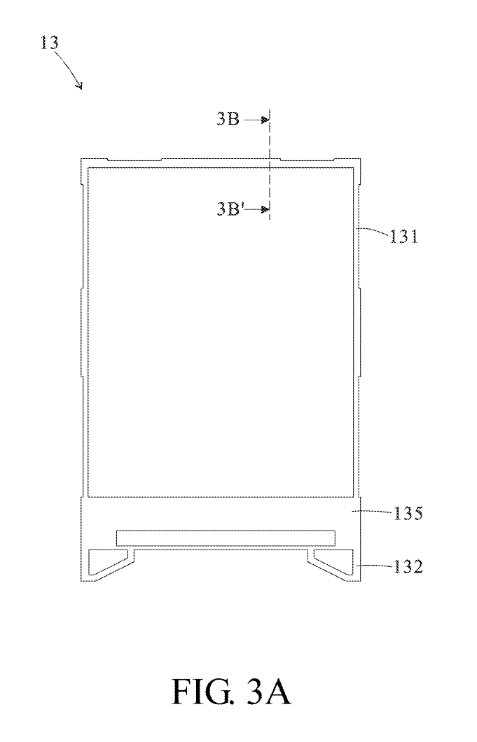

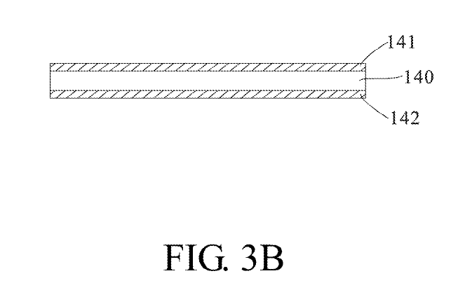

The first embodiment of the present invention is shown in FIGS. 1 to 3A. FIG. 1 is a schematic view of a display device 1 of the present invention after being assembled, FIG. 2 is an exploded view of the display device 1, and FIG. 3A is a schematic view of a tape assembly. After the display device 1 is assembled, a panel 11 is embedded into a housing 16, and an exposed portion of the panel 11 is adapted to display an image according to an input signal. In practice, the display device 1 may comprise therein many elements stacked on each other. Referring to the exploded view shown in FIG. 2, the display device 1 may further comprise, between the panel 11 and the housing 16, an optical guiding assembly 12, a tape assembly 13 and a flexible printed circuit (FPC) 15. The FPC 15 may be electrically connected to the panel 11, and the optical guiding assembly 12 is adapted to form an area light source to provide the panel 11 with adequate and uniform brightness for displaying the image.

In this embodiment, the optical guiding assembly 12 may comprise an optical film 124, a light guide plate 125, a reflective film 126 and a frame 123. The optical film 124, the light guide plate 125 and the reflective film 126 are stacked sequentially in a receiving space defined by the frame 123 to form the optical guiding assembly 12. For convenience of description, the optical guiding assembly 12 is further defined to have a first periphery 121 and a second periphery 122 opposite to each other, which are located at the periphery of an upper surface and the periphery of a lower surface of the optical guiding assembly 12 respectively. In this embodiment, the first periphery 121 refers to the periphery of the upper surface of the optical film 124, while the second periphery 122 refers to the periphery of the lower surface of the reflective film 126 and to parts of the periphery of the lower surface of the frame 123. The first periphery 121 and the second periphery 122 are adapted to have tapes adhered thereon for adhesion of the individual elements.

Further, in reference to FIG. 3A, the tape assembly 13 of this embodiment may comprise a first tape portion 131, a second tape portion 132 and a bending portion 135 connecting the first tape portion 131 and the second tape portion 132. Unlike the prior art, the first tape portion 131, the bending portion 135 and the second tape portion 132 can be formed continuously and integrally. Conceivably, the tape assembly 13 may be formed in one step by use of a single mold. The tape assembly 13 may also be made of a same material to reduce production costs and make the management of materials more convenient. Additionally, the tape assembly 13 helps to make the assembly process smooth, and reduces the number of times of retrieving and adhering tapes, thereby increasing the assembly efficiency. In addition, FIG. 3B illustrates schematic cross-sectional view of the tape assembly 13 taken along line 3B-3B′ of FIG. 3A therein. The tape assembly 13 may comprise a base film 140 made of, for example but not limited to, polyethylene terephthalate (PET). The base film 140 has an upper surface and a lower surface, which are opposite each other and applied with an adhesive respectively to form a first adhesive 141 and a second adhesive 142 opposite to each other. The tape assembly 13 may be substantially opaque; for example, the base film 140 of the tape assembly 13 may be made of opaque materials. Alternatively, the tape assembly 13 is formed with a reflective surface to avoid light leakage and even to improve the utilization factor of the light source. The tape assembly 13 may further have two release liners (not shown) disposed on the first adhesive 141 and the second adhesive 142 respectively. The release liners may be in the form of a whole sheet which may be torn down when the adhesion is done; or the release liners may be formed in several sections which are torn down separately according to the assembly sequence when adhesion is done.

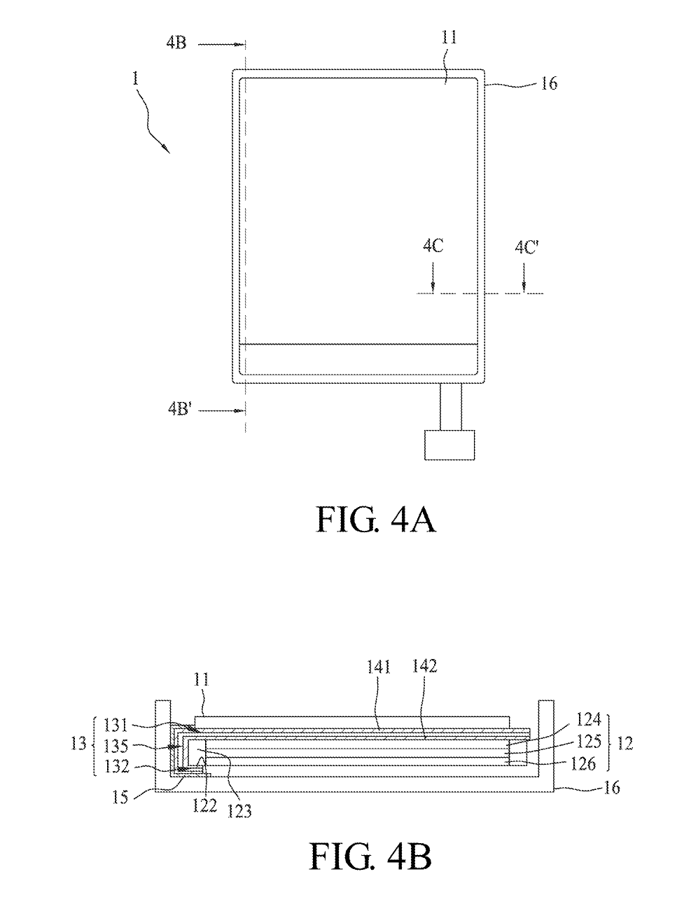

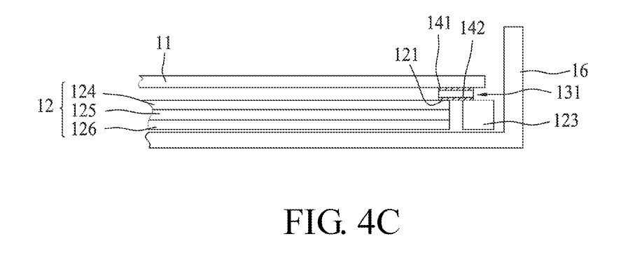

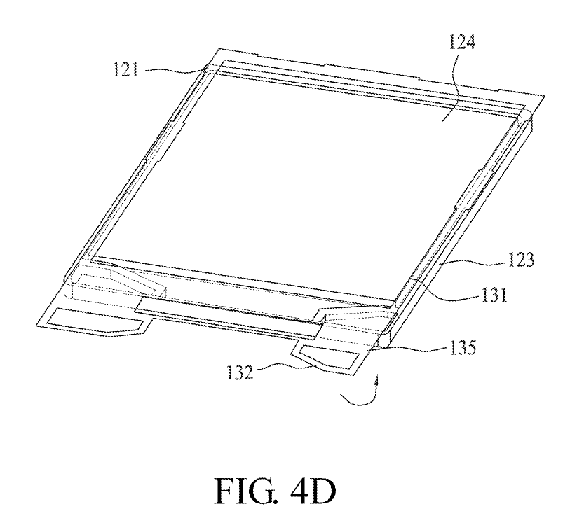

FIG. 4A illustrates a top view of the display device 1, FIG. 4B illustrates a schematic cross-sectional view of FIG. 4A taken along a line 4B-4B′, FIG. 4C illustrates a schematic cross-sectional view of FIG. 4A along a line 4C-4C′, and FIG. 4D illustrates a schematic view of the tape assembly 13 of this embodiment when being adhered. For convenience of understanding, the panel 11 is omitted in FIG. 4D. FIGS. 4B and 4C illustrate cross-sections taken along different directions to disclose the relative relationships between the tape assembly 13 and other elements in the display device 11 more clearly. It shall be appreciated that these figures and scales thereof are merely provided to disclose relative relationships among individual elements, but not to limit the present invention.

FIGS. 3A and 4B illustrate the first tape portion 131 of the tape assembly 13 that is adhered to the first periphery 121 (shown in FIGS. 2 and 4C) of the optical guiding assembly 12 by the second adhesive 142 thereof. As shown in FIGS. 4C and 4D, the first tape portion 131 is adhered across the edges of the frame 123 and the optical film 124 by the second adhesive 142 thereof along a border between the frame 123 and the optical film 124. Next, in reference to FIG. 4B again, the bending portion 135 of the tape assembly 13 is adhered to an edge of the optical guiding assembly 12 by the second adhesive 142 thereof, and finally, the second tape portion 132 of the tape assembly 13 is bent and adhered to the second periphery 122 of the optical guiding assembly 12 by the second adhesive 142 thereof. As shown in FIG. 4D, in this embodiment, the first tape portion 131 and the second tape portion 132 may be of a shape similar to a partial structure of the frame 123 in order to be adhered onto the frame 123.

Consequently, as shown in FIGS. 4B and 4C, the first adhesive 141 of the tape assembly 13 is exposed. The exposed first adhesive 141 of the first tape portion 131 is partially adhered to the edge of the panel 11 so that the panel 11 can be stacked and fixed onto the first periphery 121 of the optical guiding assembly 12. When the tape assembly 13 is bent and adhered to the optical guiding assembly 12, the bending portion 135 and the second tape portion 132 will wrap and be adhered to the frame 123, and the partially exposed first adhesive 141 of the tape assembly 13 can be adhered to the FPC 15, as shown in FIG. 4B. For example, the first adhesive 141 of the second tape portion 132 may be adhered to the FPC 15. Additionally, the dimensions, shape and scale of the second tape portion 132 may be varied depending on the practical needs, and no limitation is made thereon herein.

It shall be noted that a light source 17 (as shown in FIG. 2), preferably a light emitting diode (LED), may be further provided on the FPC 15. After the display device 1 is assembled, the light source 17 is located such that it projects light towards the light guide plate 125 to generate a uniform area light source through the light guide plate 125.

Additionally, as shown in FIG. 2, the display device 1 of this embodiment may further comprise two fixing tape strips 18, preferably dual-side tapes. Each of the fixing tape strips 18 has one side thereof adhered across edges of the frame 123 and the reflective film 126 and the other side thereof adhered to the housing 16. Thereby, the reflective film 126 can be fixed to the housing 16.

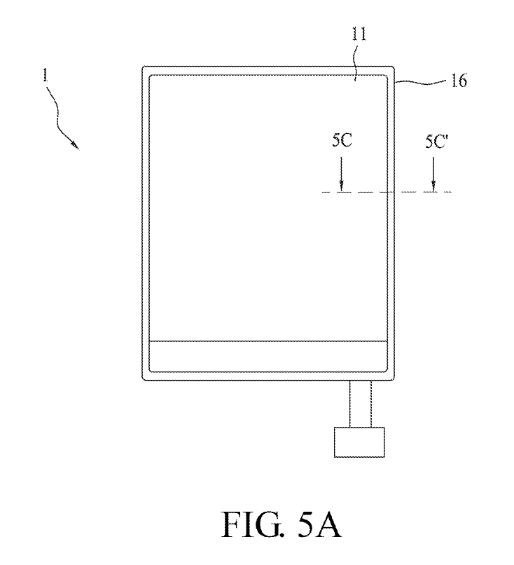

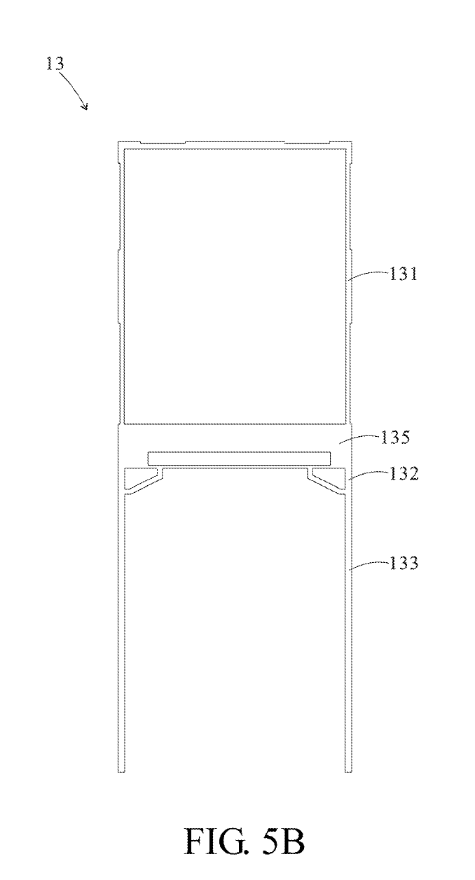

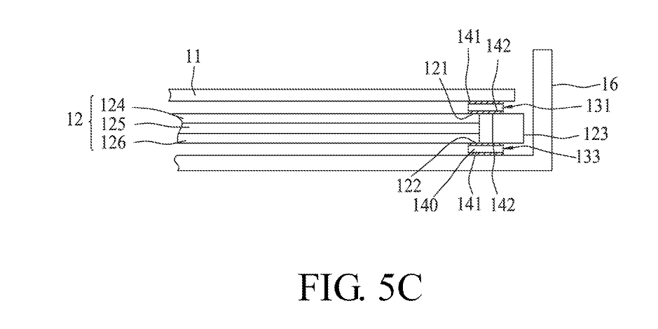

Another preferred embodiment of the present invention further integrates the tape assembly 13 of the previous embodiment with the fixing tape strips 18, as shown in FIGS. 5A to 5C. FIG. 5A illustrates the top view of the display device 1, FIG. 5B illustrates a schematic view of the tape assembly 13, and FIG. 5C illustrates a schematic cross-sectional view of FIG. 5A taken along a line 5C-5C′. The tape assembly 13 may further comprise a third tape portion 133 extending from the second tape portion 132 and is opposite the first tape portion 131. The third tape portion 133 may be in form of two strips, but it is not limited thereto and may be varied depending on the practical needs. Similar to the first tape portion 131 and the second tape portion 132, the third tape portion 133 may also comprise a base film 140 as well as a first adhesive 141 and a second adhesive 142 disposed on opposite sides of the base film 140. The third tape portion 133 is adhered to the second periphery 122 of the optical guiding assembly 12 by the second adhesive 142 thereof; more specifically, the third tape portion 133 can be adhered across the edges of the frame 123 and the reflective film 126 by the second adhesive 142 thereof in such a way that the exposed first adhesive 141 can be adapted to be adhered to the housing 16.

It shall be appreciated that the optical film 124 of the display device 1 of the present invention may include a single layer or multiple layers, for example, a diffusing film, a prism film, a brightness enhancement film, a uniform film, other complex optical films or a combination thereof. This can be determined by those of ordinary skill in the art depending on design requirements, and no limitation will be made thereon herein.

In summary, the integral and continuous tape assembly disclosed in the present invention may be fabricated by a single mold, and by using the tape assembly to assemble the display device, the manufacturing process of the display device of the present invention is simplified greatly, resulting in a significant reduction in the overall production cost.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display device, comprising:
a panel;
an optical guiding assembly having a first periphery and a second periphery opposite to the first periphery; and
a tape assembly having a first adhesive and a second adhesive opposite to the first adhesive;
wherein the tape assembly is bent and adhered to the optical guiding assembly at the first periphery and the second periphery thereof by the second adhesive in such a way that the first adhesive is exposed, and the panel is partially adhered to the first adhesive and stacked onto the first periphery of the optical guiding assembly.

2. The display device as claimed in claim 1, wherein the tape assembly comprises a first tape portion, a second tape portion and a bending portion connecting with the first tape portion and the second portion, in which the first tape portion is adhered to the first periphery of the optical guiding assembly by the second adhesive thereof, the second tape portion is adhered to the second periphery of the optical guiding assembly by the second adhesive thereof, and the bending portion is adhered to an edge of the optical guiding assembly.

3. The display device as claimed in claim 2, wherein the optical guiding assembly comprises a frame, at least one optical film, a light guide plate and a reflective film, the frame defining a receiving space for the at least one optical film, the light guide plate and the reflective film being stacked therein.

4. The display device as claimed in claim 3, wherein the first tape portion is partially adhered to the frame and the at least one optical film by the second adhesive thereof.

5. The display device as claimed in claim 2, wherein the first adhesive on the first tape portion is adhered to the panel.

6. The display device as claimed in claim 3, wherein the second tape portion is adhered to the frame by the second adhesive.

7. The display device as claimed in claim 3, further comprising a flexible printed circuit (FPC) being adhered to the first adhesive on the second tape portion.

8. The display device as claimed in claim 7, further comprising a light source disposed on the flexible printed circuit, wherein the light source provides light towards the light guide plate.

9. The display device as claimed in claim 7, wherein the flexible printed circuit is electrically connected with the panel.

10. The display device as claimed in claim 3, wherein the tape assembly further comprises a third tape portion connecting to the second tape portion and opposite to the first tape portion, the third tape portion extending from the second tape portion and being adhered to the second periphery of the optical guiding assembly.

11. The display device as claimed in claim 10, wherein the third tape portion is adhered to the frame and the reflective film by the second adhesive thereof.

12. The display device as claimed in claim 10, further comprising a housing being adhered to the first adhesive on the third tape portion.

13. The display device as claimed in claim 3, wherein the at least one optical film comprises a diffusing film, a prism film, a brightness enhancement film, a uniform film, a complex optical film or a combination thereof.

14. The display device as claimed in claim 1, wherein the tape assembly is substantially opaque.

15. The display device as claimed in claim 1, wherein the tape assembly comprises a reflective surface.

16. The display device as claimed in claim 1, wherein the tape assembly comprises a base film having two opposite surfaces being applied with an adhesive respectively to form the first adhesive and the second adhesive.

17. The display device as claimed in claim 16, wherein the base film comprises polyethylene terephthalate (PET).
